(19) United States
(12) Patent Application Publication
(10) Pub. No.: US 2014/0011293 A1
(43) Pub. Date: Jan. 9, 2014

(54) DETECTION METHOD AND DETECTION APPARATUS

(71) Applicant: FUJIFILM CORPORATION, TOKYO (JP)

(72) Inventor: Kazuyoshi HORII, Ashigarakami-gun (JP)

(73) Assignee: FUJIFILM CORPORATION, TOKYO (JP)

(21) Appl. No.: 14/021,517

(22) Filed: Sep. 9, 2013

Related U.S. Application Data
(63) Continuation of application No. PCT/JP2012/001517, filed on Mar. 6, 2012.

(30) Foreign Application Priority Data
Mar. 10, 2011 (JP) 2011-052858

(51) Int. Cl. G01N 21/64

(52) U.S. Cl. CPC G01N 21/6486
USPC 436/501; 422/69

(57) ABSTRACT

Applying an ultrasound to a sample solution by an ultrasound application unit and pressing a fluorescent labeling substance in the sample solution against a metal layer. Under this state, applying an excitation light to the interface between a dielectric plate and the metal layer at a specific angle greater than or equal to a total reflection angle by a light application unit and forming a surface plasmon enhanced optical field area on the metal layer, thereby exciting the fluorescent labeling substance. Detecting fluorescence generated from the fluorescent labeling substance through the excitation by a fluorescence detection unit.

### BACKGROUND OF THE INVENTION

1. Field of the Invention

The present invention relates to a detection method and detection apparatus for detecting a target detection substance in a sample solution.

2. Description of the Related Art

Fluorescence methods are widely used as high sensitivity and easy methods in bio-measurement and the like. The fluorescence method is a method in which a sample which is presumed to include a detection target substance that will emit fluorescence excited by light having a specific wavelength is illuminated with light having the specific wave length and fluorescence emitted at the time is detected, thereby confirming the presence of the detection target substance qualitatively or quantitatively. In the case where the detection target substance itself is not a fluorescent substance, the detection target substance is labeled with a fluorescent label, such as an organic fluorescent dye or the like, and thereafter fluorescence is detected in the same manner as described above, whereby the method confirms the presence of the detection target substance with the presence of the label.

As only a specific detection target substance can be detected efficiently by flowing the sample, it is common in the fluorescence method to immobilize the detection target substance on the surface of a sensor section by one of the following two methods and then to perform fluorescence detection. One of the methods is a so-called sandwich method in which if, for example, the detection target substance is an antigen, the antigen is specifically bound to a primary antibody immobilized on the surface of the sensor section and a secondary antibody with a fluorescent label attached thereto that will specifically bind to the antigen is further bound to the antigen to form a binding state of the primary antibody-antigen-secondary antibody, and fluorescence is detected from the fluorescent label attached to the secondary antibody. The other method is so-called a completion method in which if, for example, the detection target substance is an antigen, the antigen and a secondary antibody (which, unlike the secondary antibody described above, specifically binds to the primary antibody) with a fluorescent label attached thereto is competitively bound to the primary antibody immobilized on the sensor section, and fluorescence is detected from the fluorescent label attached to the secondary antibody competitively bound to the primary antibody.

As the S/N (signal to noise) ratio can be improved in the fluorescence detection or for other reasons, an evanescent fluorescence method in which the fluorescent label indirectly immobilized on the sensor section in the manner described above is exited by evanescent light is proposed. The evanescent fluorescence method is a method in which excitation light is applied from the rear surface of the sensor section to excite the fluorescent label by the evanescent light exuded to the front surface of the sensor section and the fluorescence generated from the fluorescent label is detected.

In the mean time, in order to improve sensitivity in the evanescent fluorescence method, methods that use an optical field enhancement effect by the plasmon resonance is proposed as described, for example, in U.S. Pat. No. 6,194,223 (Patent Document 1) and M. M. L. M. Vareiro et al., “Surface Plasmon Fluorescence Measurements of Human Chorionic Gonadotrophin: Role of Antibody Orientation in Obtaining Enhanced Sensitivity and Limit of Detection”, Analytical Chemistry, Vol. 77, No. 8, pp. 2426-2431, 2005 (Non-Patent Document 1). In the surface plasmon enhanced fluorescence method, the sensor section is provided with a metal layer for causing plasmon resonance, then the surface plasmon resonance is caused on the metal layer, and the fluorescence signal is enhanced by the optical field enhancement effect thereof, whereby the S/N ratio is improved.

In the evanescent fluorescence method, as a method having an effect of enhancing the optical field of the sensor section, as in the surface plasmon enhanced fluorescence method, a method that uses an optical field enhancement effect of optical waveguide mode is proposed as described, for example, in K. Tsuboi et al., “High-sensitive sensing of catechol amines using by optical waveguide mode enhanced fluorescence spectroscopy”, Preprints for the Spring Meeting 2007 of the Japan Society of Applied Physics, No. 3, p. 1378, 28p-SA-4, 2007 (Non-Patent Document 2). In the optical waveguide mode enhanced fluorescence spectroscopy (OWF), a metal layer and an optical waveguide layer of a dielectric material are formed on top of each other, then optical waveguide mode is caused in the optical waveguide layer, and the fluorescence signal is enhanced by the optical field enhancement effect thereof.

Further, U.S. Patent Application Publication No. 20050053974 (Patent Document 2) and T. Libermann and W. Knoll, “Surface-plasmon field-enhanced fluorescence spectroscopy”, Colloid and Surfaces, Vol. A171, pp. 115-130, 2000 (Non-Patent Document 3) proposes a method that detects, instead of detecting fluorescence from the fluorescent label as in the fluorescence method described above, radiated light (SPCE: Surface Plasmon-Coupled Emission) generated by the induction of new surface plasmon on the metal layer by the fluorescence.

As described above, various methods have been proposed as measurement methods in bio-measurements and the like.

### SUMMARY OF THE INVENTION

In the mean time, the sensitivity of the evanescent fluorescence method and the optical field enhancement effect by the surface plasmon resonance and optical waveguide mode are attenuated rapidly with distance from the measuring plane. Consequently, even a small change in the distance from the measuring plane to the fluorescent label causes a difference in the signal, thereby causing a problem of signal variation.

By way of example, FIG. 14 schematically illustrates a portion adjacent to the sensor section of a device for detecting fluorescence through optical field enhancement effect by the surface plasmon resonance. A gold film 102 is provided on a prism (substrate) 101 and a primary antibody B1 is immobilized on the gold film 102. In performing a sandwich assay, a binding state of the primary antibody B1-antigen A-labeled secondary antibody B2 is formed, as described above. Here, the labeled secondary antibody B2 is a secondary antibody with a fluorescent label (fluorescent dye molecule “f”, here) attached thereto. Then, excitation light is applied to the interface between the prism 101 and gold film 102 at an angle greater than the total reflection angle to excite surface plasmon on the gold film surface, whereby optical field on the gold film surface is enhanced. As a result, the fluorescent label “f” is excited in the enhanced optical field and emits fluorescence.

The graph in FIG. 14 illustrates distance dependence of optical field intensity from the surface of the sensor section (gold film surface). As the graph illustrates, the optical field intensity attenuates rapidly with distance from the surface. Here, a maximum distance from the surface of the sensor section to the fluorescent label “f” of the labeled secondary antibody B2 may sometimes become about 50 nm and the fluorescence intensity is attenuated by 30% or more in such a case. Further, the primary antibody B1 is not always immobilized upright and may sometimes fall down along the surface by the flow of the solution, steric barrier, and the like. Consequently, a variation may occur in the distance from the surface of the fluorescent label f according to this, which may lead to a variation in the signal strength.

The present invention has been developed in view of the circumstances described above, and it is an object of the present invention to reduce variation in detection signal intensity in a detection method and apparatus for detecting light generated through excitation of a fluorescent label, thereby providing a detection method and apparatus capable of performing stable measurements.

A detection method of the present invention is a method, including the steps of:

bringing a sample solution which includes a detection target substance into contact with a surface of a sensor section formed on a surface of a dielectric plate of a sensor chip and binding an amount of fluorescently labeled binding substance corresponding to an amount of the detection target substance included in the sample solution to the surface of the sensor section;

applying excitation light to the sensor section at an incident angle that satisfies a condition of total reflection and generating an optical field on the surface of the sensor section; and

exciting the fluorescent label of the fluorescently labeled binding substance by the optical field and detecting an amount of the detection target substance based on an amount of light generated due to the excitation of the fluorescent label,

wherein the amount of the detection target substance is detected with the detection target substance and the fluorescently labeled binding substance in the sample solution being brought into close proximity to the surface of the sensor section by applying an ultrasound to the sensor section through the sample solution.

The term “the amount of the detection target substance is detected with the detection target substance and the fluorescently labeled binding substance in the sample solution being brought into close proximity to the surface of the sensor section by applying an ultrasound to the sensor section through the sample solution” as used herein is not limited an embodiment in which the amount of the detection target is detected while the ultrasound is applied to the sensor section but also includes an embodiment in which the detection target substance and the fluorescently labeled binding substance are brought into close proximity to the surface of the sensor section by applying the ultrasound to the sensor section immediately before detection and the application of the ultrasound is stopped at the time of the detection.

In the detection method of the present invention, an arrangement may be adopted in which, as the sensor chip, a sensor chip whose sensor section has a layered structure that includes a metal layer adjacent to the dielectric plate is used, a plasmon is excited in the metal layer by the application of the excitation light and an enhanced optical field is generated by the plasmon, and, as the light generated due to the excitation of the fluorescent label, fluorescence generated from the fluorescent label by the excitation is detected.

In the case of detection using the plasmon enhancement, if the fluorescently labeled binding substance in the sample is in too close to the metal layer, a phenomenon that fluorescence is not generated (so-called metal quenching) may possibly occur because the energy exited in the fluorescently labeled binding substance is transited to the metal layer before generating fluorescence.

In order to resolve such a problem, the use of a quench prevention substance as the fluorescently labeled binding substance or the use of a sensor chip whose sensor section has a layered structure that includes a quench prevention layer as the sensor chip is preferable.

Further, as the sensor chip, a sensor chip whose sensor section has a layered structure that includes an ultrasound matching layer and/or an ultrasound absorption layer may be used.

A detection apparatus of the present invention is an apparatus for use with the detection method described above, the apparatus including:

an accommodation section for accommodating the sensor chip;

an excitation light application unit for applying the excitation light at the position of the sensor section of the sensor chip accommodated in the accommodation section;

a light detection unit for detecting the amount of the light generated due to the excitation of the fluorescent label by the optical field; and

an ultrasound application unit for applying an ultrasound to the position of the sample solution on the surface of the sensor section of the sensor chip accommodated in the accommodation section.

In the detection apparatus of the present invention, the light detection unit may be disposed above the position of the sensor section of the sensor chip accommodated in the accommodation section and the ultrasound application unit may be disposed above the sensor section and on a side of the light detection unit so as to be able to apply the ultrasound toward the sensor section.

Further, an arrangement may be adopted in which the ultrasound application unit is transparent to the light and the ultrasound application unit is disposed between the light detection unit and the sensor section of the sensor chip accommodated in the accommodation section.

According to the detection method and detection apparatus of the present invention, in the case where a sample solution which includes a detection target substance is brought into contact with a surface of a sensor section formed on a surface of a dielectric plate of a sensor chip and an amount of fluorescently labeled binding substance corresponding to an amount of the detection target substance included in the sample solution is bound to the surface of the sensor section, then an excitation light is applied to the sensor section at an incident angle that satisfies a condition of total reflection and an optical field is generated on the surface of the sensor section, and the fluorescent label of the fluorescently labeled binding substance is excited by the optical field and an amount of the detection target substance is detected based on an amount of light generated due to the excitation of the fluorescent label, the amount of the detection target substance is detected with the positions of the detection target substance and the fluorescently labeled binding substance being stably placed adjacent to the sensor section where detection sensitivity is high by applying an ultrasound to the sensor section through the sample solution at the time of detection. This may reduce the variation in the detection signal intensity and allows stable measurements under high sensitivity conditions.

Further, if an arrangement is adopted in which, as the sensor chip, a sensor chip whose sensor section has a layered structure that includes a metal layer adjacent to the dielectric plate is used, a plasmon is excited in the metal layer by the application of the excitation light and an enhanced optical field is generated by the plasmon, and, as the light generated due to the excitation of the fluorescent label, fluorescence generated from the fluorescent label by the excitation is detected, the fluorescence signal is enhanced by the action of the optical filed enhancement of the prasmon, whereby the S/N ratio may be improved.

In the case where the plasmon enhancement is used, if the fluorescently labeled binding substance is in too close to the metal layer, a phenomenon that fluorescence is not generated (so-called metal quenching) may possibly occur because the energy exited in the fluorescently labeled binding substance is transited to the metal layer before generating fluorescence. But, the use of a quench prevention substance as the fluorescently labeled binding substance or the use of a sensor chip whose sensor section has a layered structure that includes a quench prevention layer as the sensor chip may resolve the metal quenching problem.

Still further, the use of a sensor chip whose sensor section has a layered structure that includes an ultrasound matching layer and/or an ultrasound absorption layer, as the sensor chip, allows the generation of reflected ultrasound in a direction opposite to that in which the detection target substance and fluorescently labeled binding substance in the sample solution are brought close to the surface of the sensor section to be reduced when the ultrasound is applied, so that the detection target substance and fluorescently labeled binding substance may be brought into close proximity to the surface of the sensor section.

### BRIEF DESCRIPTION OF THE DRAWINGS

FIG. 1 is a schematic view of a fluorescence detection apparatus according to a first embodiment of the present invention.

FIG. 2 is a block diagram of the fluorescence detection apparatus described above.

FIG. 3 schematically illustrates, by way of example, an analysis chip used in the fluorescence detection apparatus described above.

FIG. 4 is a schematic diagram, illustrating the state in which a sample is extracted from a sample container by the sample processing unit shown in FIG. 2 using a nozzle chip.

FIG. 5 is a schematic diagram, illustrating the state in which the sample in the nozzle chip is injected into a reagent cell and stirred.

FIG. 6 illustrates, by way of example, the light application unit, ultrasound application unit, and fluorescence detection unit of FIG. 2.

FIG. 7 schematically illustrates an alternative example of the analysis chip of FIG. 3.

FIG. 8 is a graph illustrating the state in which a quantitative or qualitative analysis is performed by a rate method in the data analysis unit in FIG. 2.

FIG. 9 is a schematic diagram of a fluorescence detection apparatus according to a second embodiment of the present invention.

FIG. 10 is a schematic diagram of a modification of the fluorescence detection apparatus described above.

FIG. 11 schematically illustrates, by way of example, an analysis chip in the fluorescence detection apparatus of the present invention.

FIG. 12 schematically illustrates, by way of example, an analysis chip in the fluorescence detection apparatus of the present invention.

FIG. 13 schematically illustrates, by way of example, an analysis chip in the fluorescence detection apparatus of the present invention.

FIG. 14 is a conceptual diagram illustrating a detection method in a conventional example.

### DESCRIPTION OF THE PREFERRED EMBODIMENTS

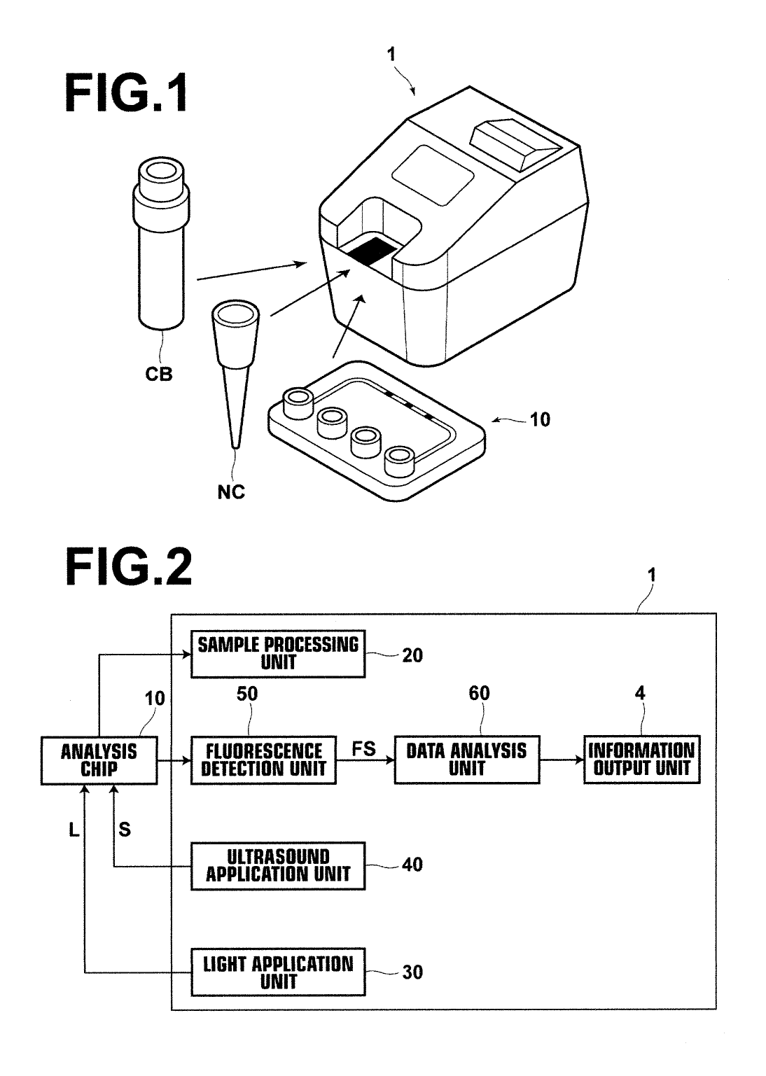

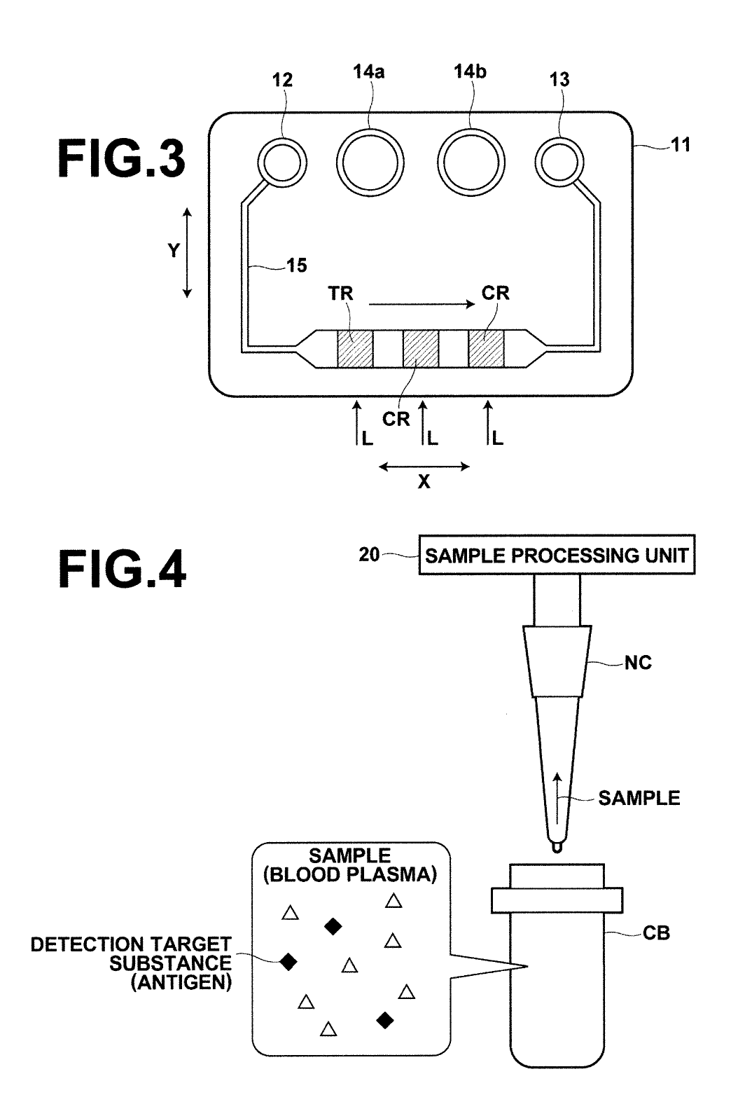

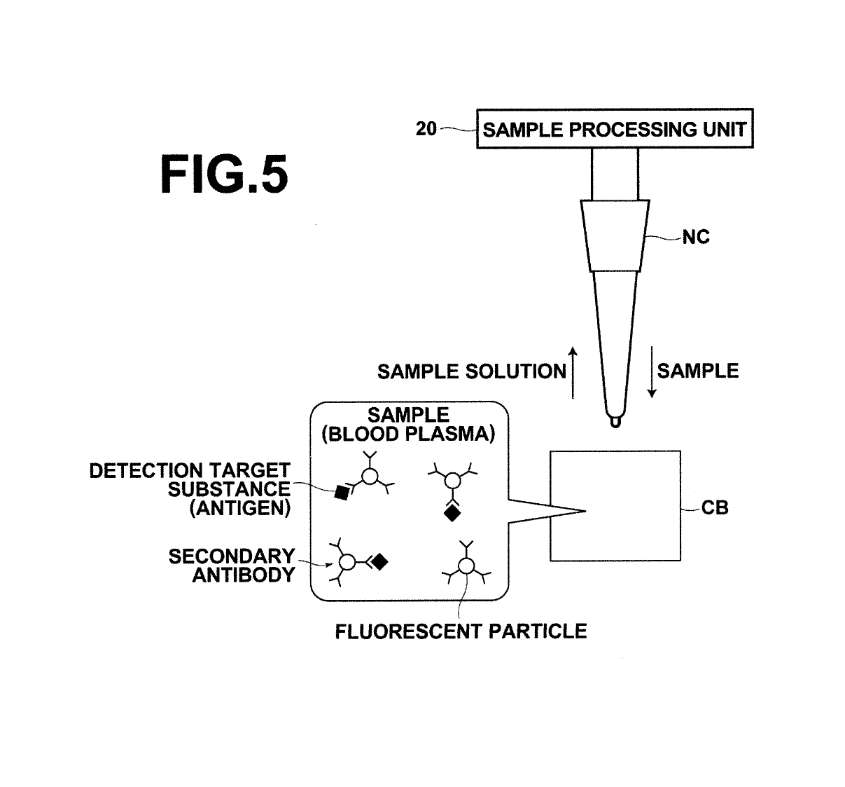

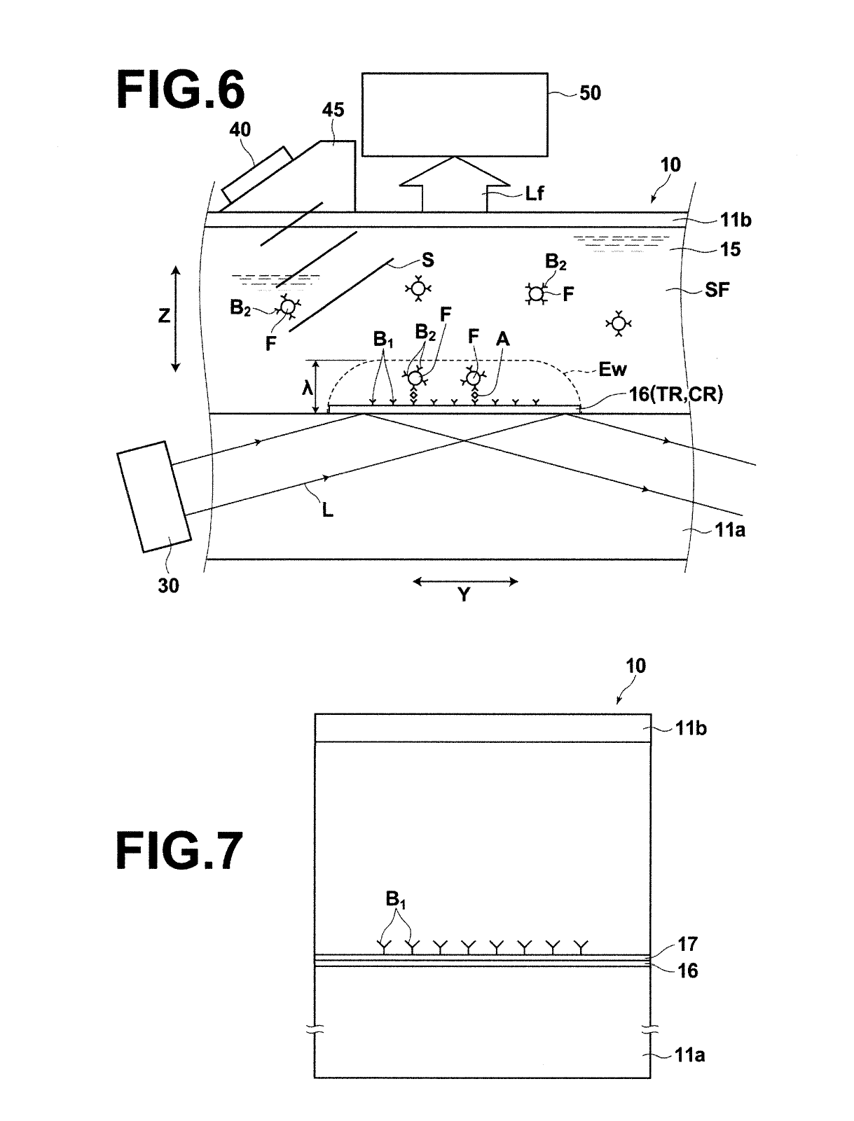

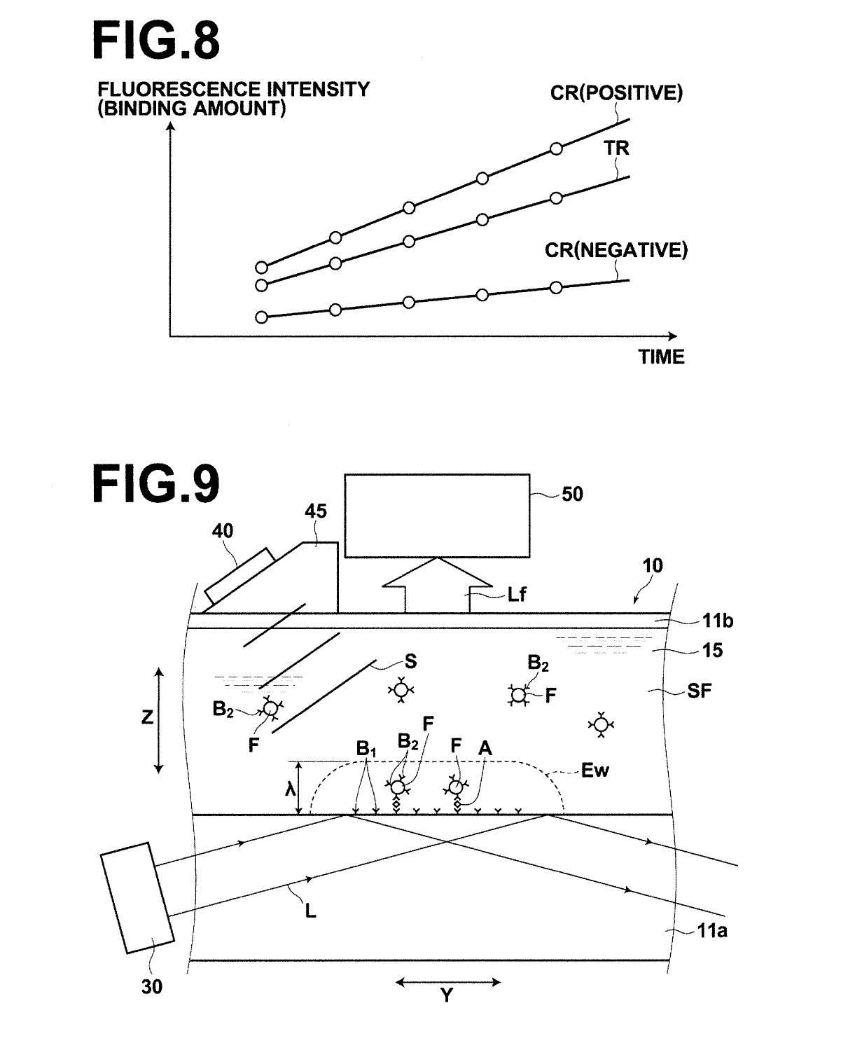

Hereinafter, a first embodiment of the present invention will be described in detail with reference to the accompanying drawings. FIG. 1 is a schematic view of a fluorescence detection apparatus according to the first embodiment of the present invention, FIG. 2 is a block diagram of the fluorescence detection apparatus described above, FIG. 3 schematically illustrates, by way of example, an analysis chip used in the fluorescence detection apparatus described above, FIG. 4 is a schematic diagram, illustrating the state in which a sample is extracted from a sample container by the sample processing unit shown in FIG. 2 using a nozzle chip, FIG. 5 is a schematic diagram, illustrating the state in which the sample in the nozzle chip is injected into a reagent cell and stirred, FIG. 6 illustrates, by way of example, the light application unit, ultrasound application unit, and fluorescence detection unit of FIG. 2, FIG. 7 schematically illustrates an alternative example of the analysis chip of FIG. 3, and FIG. 8 is a graph illustrating the state in which a quantitative or qualitative analysis is performed by a rate method in the data analysis unit in FIG. 2.

The fluorescence detection apparatus 1 is an immunology analyzer. When an analysis is performed using the fluorescence detection apparatus 1, a sample container CB containing a sample, a nozzle tip NC used for extracting the sample, and a reagent shown in FIG. 1 are loaded. In addition, an analysis chip 10 having a micro-channel and reagent cells formed thereon is accommodated in an accommodation section of the fluorescence detection apparatus 1. The sample container CB, nozzle chip NC and analysis chip 10 are for single-use only and disposed after used once. While a sample is flowed in a micro-channel 15 of the analysis chip 10, the fluorescence detection apparatus 1 performs a quantitative or qualitative analysis for a detection target substance in the sample.

As illustrated in FIG. 2, the fluorescence detection apparatus 1 includes a sample processing unit 20, a light application unit 30, an ultrasound application unit 40, a fluorescence detection unit 50, a data analysis unit 60, and the like.

The sample processing unit 20 extracts a sample from the sample container CB containing the sample using the nozzle chip NC and stirringly mixes the extracted sample with a reagent to produce a sample solution.

As illustrated in FIG. 3, the analysis chip 10 has a structure in which an inlet 12, an outlet 13, reagent cells 14a, 14b, and a channel 15 are formed on the body 11 of a light transmissive resin. The inlet 12 is in communication with the outlet 13 via the channel 15, and a sample is injected from the inlet 12, flowed through the channel 15, and discharged from the outlet 13 by applying a negative pressure from the outlet 13. The reagent cells 14a, 14b are containers for containing a fluorescent reagent (second antibody) to be mixed with the sample in the sample container CB. The opening of each of the reagent cells 14a, 14b is sealed with a seal member and the seal member is perforated when the sample is mixed with the fluorescent reagent.

The channel 15 includes a test region TR for detecting a target substance in the sample and control regions CR formed downstream of the test region TR. The primary antibody is immobilized on the test region TR and captures an antibody labeled by the so-called sandwich method. A reference antibody is immobilized on the control region CR and the fluorescent substance is captured by the reference antibody when the sample solution is flowed over the control region CR. Two control regions CR are formed, one of which is so-called a negative control region for detecting non-specific adsorption and the other of which is so-called a positive control region for detecting a difference in reactivity due to sample difference.

Then, when an analysis start instruction is given, the sample is suctioned from the sample container CB by the sample processing unit 20 using the nozzle chip NC, as illustrated in FIG. 4. Thereafter, the sample processing unit 20 perforates the seal member of the reagent cell 14a to stirringly mix the sample with the reagent in the reagent cell 14a and again suctions the sample solution using the nozzle chip NC, as illustrated in FIG. 5. This operation is also performed with the reagent cell 14b. As a result, a sample solution SF is produced in which a fluorescent labeling substance F (more precisely, a secondary antibody B2 modified on the surface of the fluorescent labeling substance F) and a detection target substance (antigen) A are bound. Then, the sample processing unit 20 sets the nozzle chip NC containing the sample solution SF to the inlet 12 and the sample solution in the nozzle chip NC flows into the channel 15 by the negative pressure applied from the outlet 13.

Here, the description has been made of a case in which the sample solution SF in which a sample and a reagent are mixed is supplied to the channel 15, but an arrangement may be adopted in which the reagent is provided in the channel 15 in advance and only the sample is flowed into the channel 15 from the inlet 12 by the sample processing unit 20.

Next, the light application unit 30, ultrasound application unit 40, and fluorescence detection unit 50 will be described with reference to FIG. 6. FIG. 6 focuses on the test region TR, but excitation light L is also applied to the control region CR.

The light application unit 30 applies excitation light L to the interface between a dielectric plate 11a and a metal layer 16 of the test region TR from a side of the analysis chip 10 via a prism at an incident angle that satisfies a condition of total reflection.

The ultrasound application unit 40 is a unit that uses the thickness vibration mode of a piezoelectric device and a piezoelectric ceramic is usually used, but not limited to this. The ultrasound application unit 40 is a unit for pressing the fluorescent labeling substance F in the sample solution SF against the metal layer 16 by the radiation pressure of the ultrasound. The resonance frequency of the piezoelectric device is, for example, 7 MHz, but not limited to this and may be selected as appropriate according to the structure of the analysis chip 10 and property of the sample solution SF.

In the case of detection using the plasmon enhancement, if the fluorescent labeling substance F in the sample solution SF is pressed against the metal layer 16, as described above, metal quenching may occur and sensitivity may be degraded. But the provision of a quench prevention layer 17 of silica, polystyrene, or the like on the metal layer 16, as illustrated in FIG. 7, may solve such a problem.

The metal quenching problem may also be solved by turning the fluorescent labeling substance F into a quench prevention substance, for example, by encapsulating a fluorescent dye in a polystyrene or silica particle or by coating a gold colloid surface with polystyrene.

The fluorescence detection unit 50 includes, for example, a photodiode, CCD, CMOS, or the like and detects fluorescence generated from the test region TR through the application of the excitation light by the light application unit 30 as a fluorescence signal FS.

Preferably, the fluorescence detection unit 50 is disposed right above the metal layer 16 for efficiently detecting fluorescence generated from the test region TR. For this reason, the ultrasound application unit 40 is brought into contact with the analysis chip 10 on a side of the fluorescence detection unit 50 via a spacer 45 inclined to the metal layer 16 so as not to interrupt the fluorescence detection by the fluorescence detection unit 40. Contrary to this, an arrangement may be adopted in which the ultrasound application unit 40 is disposed right above the metal layer 16 and the fluorescence detection unit 50 is disposed on a side of the ultrasound application unit 40.

At the time of detection, an ultrasound S is applied to the sample solution SF by the ultrasound application unit 40 and the fluorescent labeling substance F in the sample solution SF is pressed against the metal layer 16. Under this state, the excitation light L is applied to the interface between the dielectric plate 17 and metal layer 16 by the light application unit 30 at a specific incident angle which is greater than or equal to a total reflection angle. This causes an evanescent wave Ew to be exuded into the sample solution SF over the metal layer 16 and surface plasmon is excited by the evanescent wave Ew. The surface plasmon causes a field distribution on the surface of the metal layer 16 and enhanced optical field area is formed. Then, the bound fluorescent labeling substance F is excited by the evanescent wave Ew and emits enhanced fluorescence.

The data analysis unit 60 in FIG. 2 is a unit that performs analysis of detection target substance based on a temporal change in the fluorescence signal FS detected by the fluorescence detection unit 50. More specifically, the fluorescence intensity varies with time, as illustrated in FIG. 8, since the fluorescence intensity varies with the binding amount of fluorescent labeling substance. The data analysis unit 60 performs a quantitative analysis (rate method) of the detection target substance in the sample by obtaining a plurality of fluorescence signals FS at a predetermined sampling period (e.g., five second period) within a predetermined time (e.g., five minutes) and analyzing the time rate of change in the fluorescence intensity. The analysis result is outputted from the information output unit 4, such as a monitor, printer, or the like.

As an embodiment like that described above, stable measurements may be made under high sensitivity conditions with a reduced variation in detection signal intensity by detecting the amount of detection target substance with the fluorescent labeling substance F being stably positioned adjacent to the metal layer 16 where detection sensitivity is high at the time of detection.

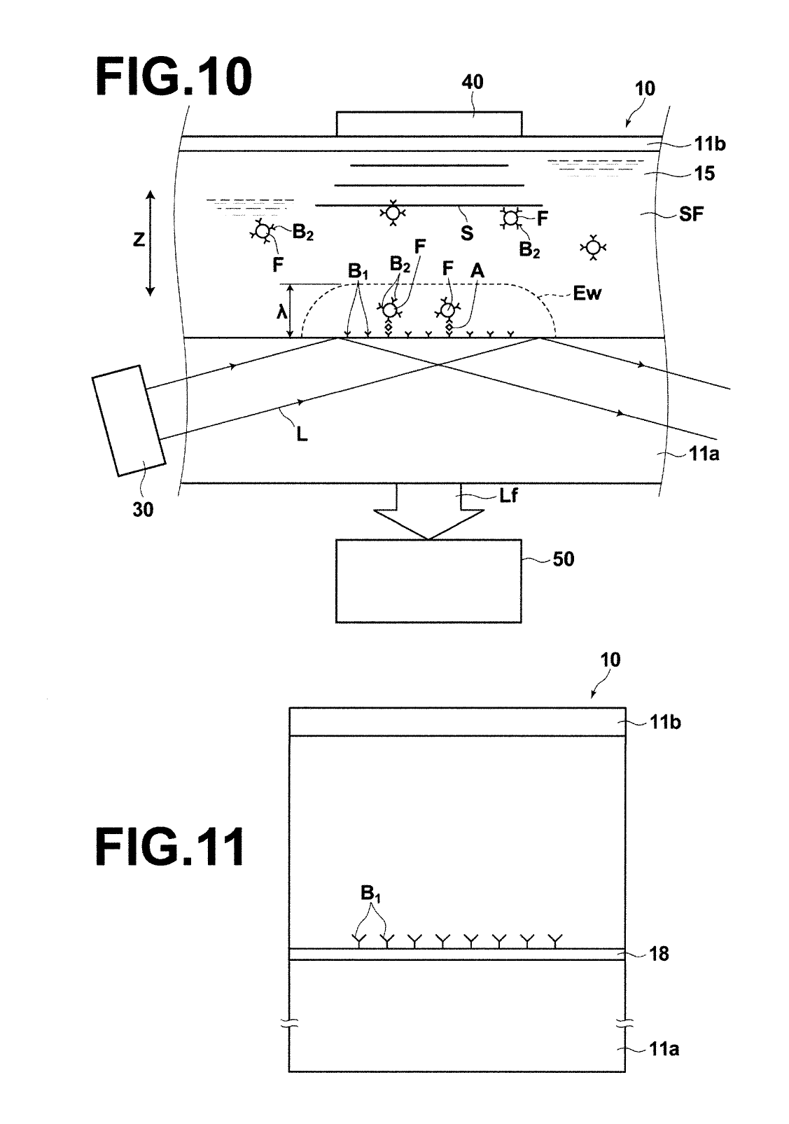

Next, a second embodiment of the present invention will be described. FIG. 9 is a schematic diagram of a fluorescence detection apparatus according to the second embodiment of the present invention and FIG. 10 is a schematic diagram of a modification of the fluorescence detection apparatus described above.

Whereas the fluorescence detection apparatus of the first embodiment corresponds to the surface plasmon enhanced fluorescence method, the fluorescence detection apparatus of the present embodiment corresponds to the evanescent fluorescence method which does not use the optical field enhancement by the surface plasmon. Other aspects are identical to those of the first embodiment and identical points will not be elaborated upon further here.

As illustrated in FIG. 9, the fluorescence detection apparatus corresponding to the evanescent fluorescence method may have a structure identical to that of the fluorescence detection apparatus of the first embodiment described mainly with reference to FIG. 6 other than not requiring the metal layer.

As the evanescent fluorescence method does not require a metal layer, the light application unit 30 may be disposed under the analysis chip 10, as illustrated in FIG. 10. In this case, the ultrasound application unit 40 may be disposed right above the detection region, so that the fluorescent labeling substance F in the sample solution SF may be pressed against the detection region efficiently.

So far, preferred embodiments of the present invention have been described, but it should be understood that the invention is not limited to the embodiments described above.

For example, in the embodiments described in FIGS. 6, 9, and 10, if the ultrasound application unit 40 is transparent to the detection light, such as PVDF (polyvinylidene fluoride), the fluorescence detection unit 50 may be disposed on the ultrasound application unit 40. In this case, both the ultrasound application and fluorescence detection may be performed efficiently by disposing the ultrasound application unit 40 and the fluorescence detection unit 50 right above the detection region.

As illustrated in FIG. 11, an ultrasound absorption layer 18 may be provided on the dielectric plate 11a, and such embodiment allows the generation of reflected ultrasound in a direction opposite to the direction in which the detection target substance and fluorescently labeled binding substance in the sample solution are brought close to the surface of the sensor section to be reduced when the ultrasound is applied, so that the detection target substance and fluorescently labeled binding substance may be brought into close proximity to the surface of the sensor section. As for the material of the ultrasound absorption layer 18, any material generally known as an ultrasound absorption body, such as rubber, urethane, silicon rubber, or the like, may be used.

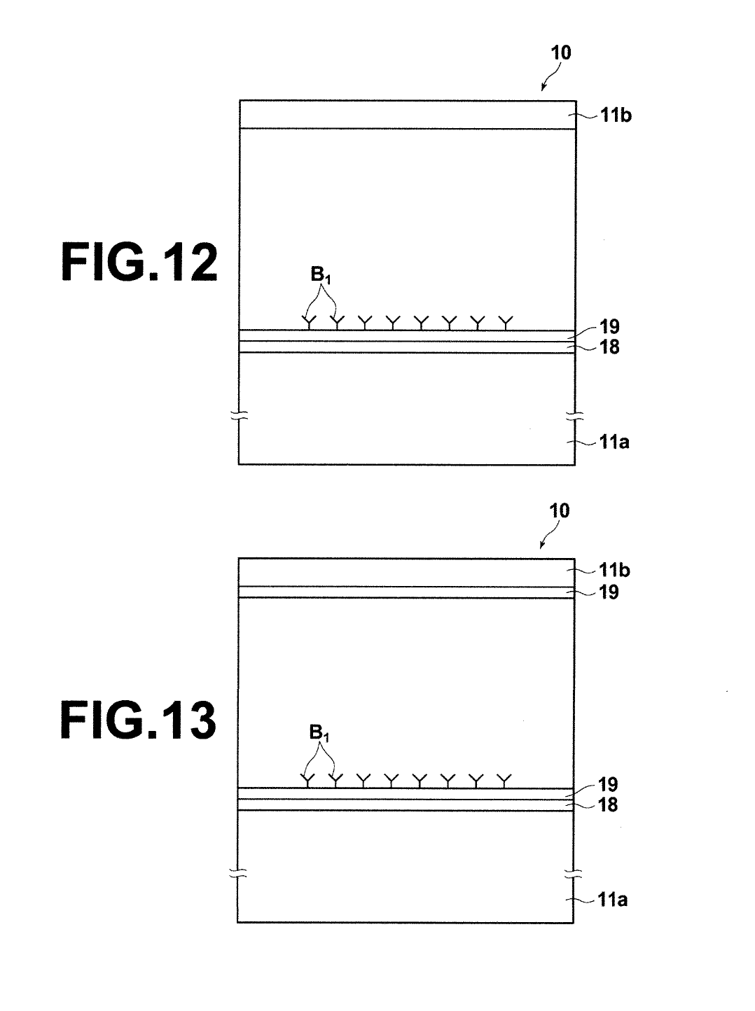

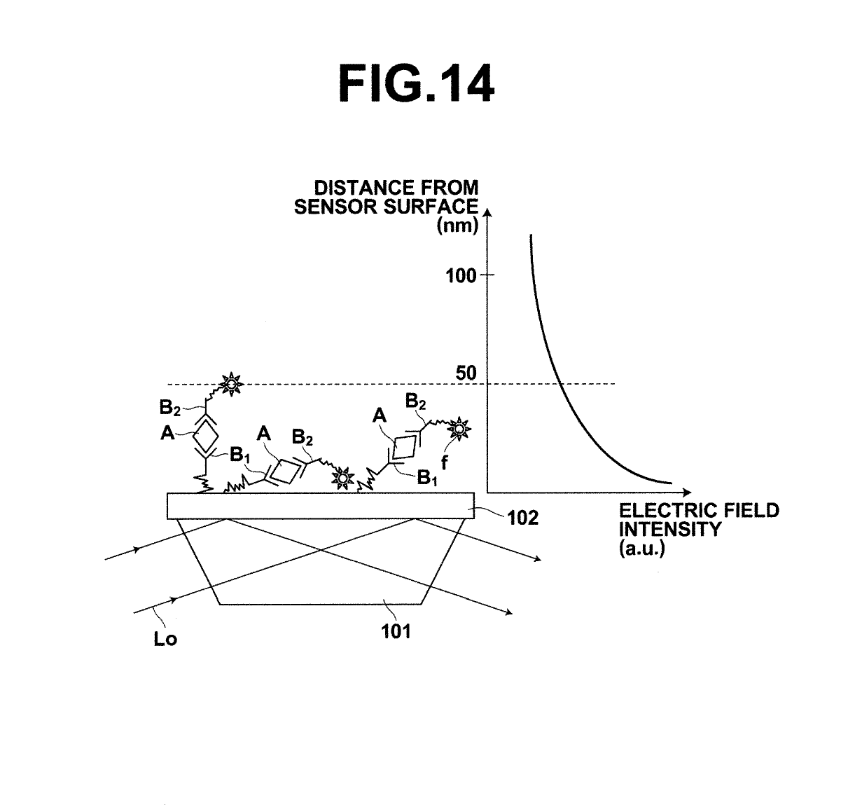

Note that even where the ultrasound absorption layer 18 is provided, it is difficult to completely prevent the generation of reflected ultrasound at the surface of the ultrasound absorption layer 18. In such a case, provision of an ultrasound matching layer 19 for matching the acoustic impedance between the ultrasound absorption layer 18 and liquid sample on the ultrasound absorption layer 18, as illustrated in FIG. 12, may keep down the generation of reflected ultrasound at the surface of the ultrasound absorption layer 18. As for the material of the ultrasound matching layer 19, any material generally known as an ultrasound matching body may be used.

Further, if the ultrasound matching layer 19 for matching the acoustic impedance between the channel wall 11b and liquid sample is also provided under the lower surface of the channel wall 11b, the generation of reflected ultrasound at the lower surface of the channel wall 11b may be reduced and the ultrasound may be efficiently applied to the liquid sample. Also for this ultrasound matching layer 19, any material generally known as an ultrasound matching body may be used.

FIGS. 11, 12, and 13 are examples of fluorescence detection apparatuses corresponding to the evanescent fluorescence method. In the case of a fluorescence detection apparatus corresponding to the surface plasmon enhanced fluorescence method, the ultrasound absorption layer may be provided on the metal layer 18.

The fluorescence detection apparatus of the present invention may be applied to various methods, such as the optical waveguide mode enhanced fluorescence spectroscopy and the like, other than the surface plasmon enhanced fluorescence method and evanescent fluorescence method.

It should be understood that various modifications and changes may be made without departing from the spirit of the present invention other than those described above.

What is claimed is:

1. A detection method, comprising the steps of:
bringing a sample solution which includes a detection target substance into contact with a surface of a sensor section formed on a surface of a dielectric plate of a sensor chip and binding an amount of fluorescently labeled binding substance corresponding to an amount of the detection target substance included in the sample solution to the surface of the sensor section;
applying excitation light to the sensor section at an incident angle that satisfies a condition of total reflection and generating an optical field on the surface of the sensor section; and
exciting the fluorescent label of the fluorescently labeled binding substance by the optical field and detecting an amount of the detection target substance based on an amount of light generated due to the excitation of the fluorescent label,
wherein the amount of the detection target substance is detected with the detection target substance and the fluorescently labeled binding substance in the sample solution being brought into close proximity to the surface of the sensor section by applying an ultrasound to the sensor section through the sample solution.

2. The detection method of claim 1, wherein:
as the sensor chip, a sensor chip whose sensor section has a layered structure that includes a metal layer adjacent to the dielectric plate is used;
a plasmon is excited in the metal layer by the application of the excitation light and an enhanced optical field is generated by the plasmon; and
as the light generated due to the excitation of the fluorescent label, fluorescence generated from the fluorescent label by the excitation is detected.

3. The detection method of claim 2, wherein, as the fluorescently labeled binding substance, a quench prevention substance is used.

4. The detection method of claim 2, wherein, as the sensor chip, a sensor chip whose sensor section has a layered structure that includes a quench prevention layer is used.

5. The detection method of claim 1, wherein, as the sensor chip, a sensor chip whose sensor section has a layered structure that includes an ultrasound matching layer is used.

6. The detection method of claim 1, wherein, as the sensor chip, a sensor chip whose sensor section has a layered structure that includes an ultrasound absorption layer is used.

7. A detection apparatus for use with the detection method of claim 1, the apparatus comprising:
an accommodation section for accommodating the sensor chip;
an excitation light application unit for applying the excitation light at the position of the sensor section of the sensor chip accommodated in the accommodation section;
a light detection unit for detecting the amount of the light generated due to the excitation of the fluorescent label by the optical field; and
an ultrasound application unit for applying an ultrasound to the position of the sample solution on the surface of the sensor section of the sensor chip accommodated in the accommodation section.

8. The detection apparatus of claim 7, wherein:
the light detection unit is disposed above the position of the sensor section of the sensor chip accommodated in the accommodation section; and
the ultrasound application unit is disposed above the sensor section and on a side of the light detection unit so as to be able to apply the ultrasound toward the sensor section.

9. The detection apparatus of claim 7, wherein:
the ultrasound application unit is transparent to the light; and
the ultrasound application unit is disposed between the light detection unit and the sensor section of the sensor chip accommodated in the accommodation section.
